(19) United States
(12) Patent Application Publication
(10) Pub. No.: US 2023/0186244 A1
(43) Pub. Date: Jun. 15, 2023

(54) CREATIVE WORK COLLABORATION SYSTEM

(71) Applicant: Charles Isgar, Scottsdale, AZ (US)

(72) Inventor: Charles Isgar, Scottsdale, AZ (US)

(21) Appl. No.: 18/164,050

(22) Filed: Feb. 3, 2023

Related U.S. Application Data
(63) Continuation-in-part of application No. 17/192,075, filed on Mar. 4, 2021, now abandoned.
(60) Provisional application No. 62/985,297, filed on Mar. 4, 2020.
(60) Provisional application No. 62/985,295, filed on Mar. 4, 2020.

(51) Int. Cl. G06Q 10/10

(52) U.S. Cl. CPC G06Q 10/103

(57) ABSTRACT

Described is a creative work collaboration system. The system includes a server having a memory storing user information and a plurality of creator computing devices coupled to the server. The server may be programmed to receive and store creative work contributions sent from each creator computing device. Further the server may be programmed to automatically process the creative work contributions and organize the creative work contributions as a unified creative work and automatically store the unified creative work with capability of updating the unified creative work. The server may also be programmed to automatically deliver the unified creative work to the plurality of creator computing devices for engagement by the plurality of creator computing devices. The system allows a group of users to contribute to the development/creation of a creative work, such as, but not limited to a book, a song, a drawing, a painting, an application or the like.

### CROSS REFERENCE TO RELATED APPLICATION

This application is a continuation-in-part of U.S. Patent Application entitled “CREATIVE WORK COLLABORATION SYSTEM,” Ser. No. 17/192,075, filed Mar. 4, 2021, which claims priority to U.S. Provisional Patent Applications entitled “CREATIVE WORK COLLABORATION SYSTEM,” Ser. No. 62/985,297, filed Mar. 4, 2020, and “CREATIVE WORK CONTRIBUTION SYSTEM,” Ser. No. 62/985,295, filed Mar. 4, 2020, the disclosures of which are hereby incorporated entirely herein by reference.

### BACKGROUND OF THE INVENTION

### Technical Field

This invention generally relates to a system for creation of a creative work, and more specifically to a creative work collaboration system for group development/creation of a creative work.

### State of the Art

Many creative individuals can often draw inspiration, motivation and the like from other creative individuals. This is true for authors, artists, musicians, photographers, coders and the like. Conventionally, group creative works are done by people independently working on a portion, sharing it with others through certain means and trying to piece together the work. Other group works are created with all of the creators in a single location. There does not exist a system that would allow a group of creators an opportunity to engage through a system that allows for near real-time contribution and sharing as part of the collaborative effort to create a work, such as, but not limited to, a book, a poem, a song, artwork, software code, advertisements and the like.

Accordingly, what is needed is a creative work collaboration system for group development/creation of a creative work.

### SUMMARY OF THE INVENTION

An embodiment includes a creative work collaboration system comprising: a server having a memory storing user information; and a plurality of creator computing devices of creators coupled to the server, wherein the server is programmed to receive and store creative work contributions sent from each of the plurality of creator computing device; automatically process the creative work contributions and organize the creative work contributions as a unified creative work; automatically store the unified creative work with capability of updating the unified creative work; and automatically deliver the unified creative work to the plurality of creator computing devices for engagement by the plurality of creator computing devices. The plurality of creator computing devices may each be a mobile computing device. A mobile application may operate on each of the plurality of creator computing device. The mobile application operating on the mobile computing device may provide a voting interface for the creators to vote on the unified creative work. The mobile application operating on the mobile computing device may provide a display interface for the display of the unified creative work that each of the creators contributed to. The display interface may comprise the ability of each of the creators to confirm or reject each of the creative work contributions displayed. The user information may comprise demographic information of each of the creators. The user information may comprise profile information of each of the creators. The profile information may comprise skill level, rating level and/or activity level of each of the creators. Each of the creators may be located at different locations. The creators may form a group for collaboration on the unified creative work. The server may designate areas of the memory for the unified creative work generated by the collaboration group. A threshold amount of the creative work contributions of each of the creators may need to be met in order to be listed as one of the creators of the unified creative work. The updating may comprise adding or deleting portions of the unified creative work.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of a creative work collaboration system according to an embodiment;

FIG. 2 depicts a creative work collaboration system with several writers engaging in creating a single novel according to an embodiment;

FIG. 3 depicts a creator computing device operating as part of a creative work collaboration system to engage with contributions by a plurality of creators as a unified creative work according to an embodiment;

FIG. 4 depicts a creator computing device operating as part of a creative work collaboration system with an artist engaging with contributions by other creators to modify unified creative work according to an embodiment;

FIG. 5 depicts a creator computing device operating as part of a creative work collaboration system with a plurality of coders engaging in creating an application according to an embodiment;

FIG. 6 depicts a creator computing device operating as part of a creative work collaboration system depicting a voting interface for other users of the system to vote on unified creative works according to an embodiment;

FIG. 7 depicts a view of various individuals contributing to creative works from various locations according to an embodiment;

FIG. 8 depicts profile of a member of a creative work collaboration system according to an embodiment;

FIG. 9 depicts a creator computing device depicting a list of components creative work contributions as part of a unified creative work and presenting each component creative work contributions for confirmation or rejection by the other creators of the unified creative work according to an embodiment;

FIG. 10 depicts a creator computing device operating to view a plurality of unified creative works available for providing opinion input by other users according to an embodiment; and

FIG. 11 depicts a creator computing device operating to view a plurality of unified creative works available for providing contribution input by other users according to an embodiment.

### DETAILED DESCRIPTION OF EMBODIMENTS OF THE INVENTION

Embodiments of the present invention relate to creative work collaboration system for group development/creation of a creative work. The system may include the use of a mobile application operating on a creator computing device that may be a mobile computing device like a smartphone, a tablet, a wearable, and the like; and/or the system may operate on any type of computing device as a downloadable application or even as a web application.

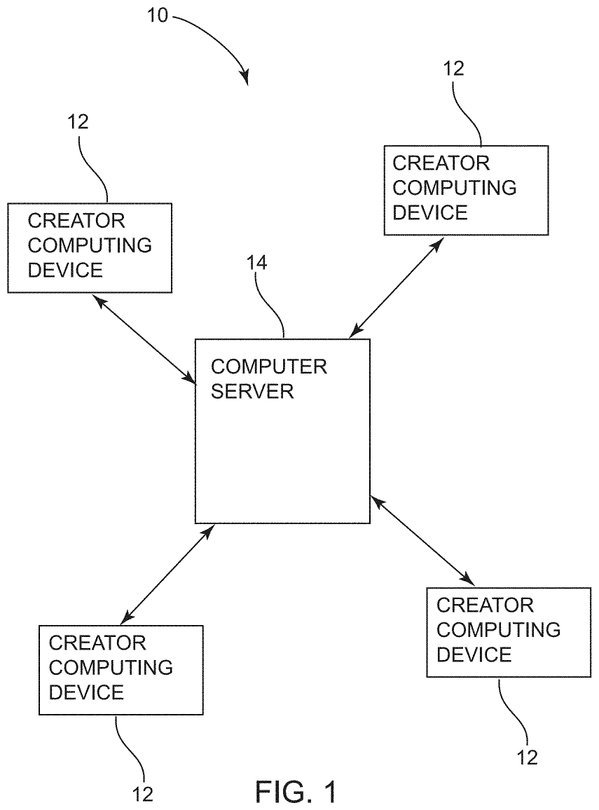

FIG. 1 depicts an embodiment of a creative work collaboration system 10. The system 10 may include a plurality of creator computing devices 12 and a server 14, wherein the creator computing devices 12 are coupled to the computer server 14. This coupling may be a network connection, such as a wireless connection through an Internet connection, a 5G connection, a Wi-Fi connection, a Bluetooth connection or the like, wherein each creator computing device 12 may communicate with and receive communication from the server 14. Each creator computing device 12 may include a desktop computer, a laptop, a tablet, a smartphone, wearable devices and the like. The server 14, in some embodiments, may be a computer server or a cloud-based infrastructure architecture.

The server 14 may include a memory storing various data. The memory of the server 14 may store user information, such as demographic information, and may further store creative work contributions given and received relating to each creator and the demographic information of the creator(s).

The plurality of creator computing devices 12 may each be coupled to the server 14, and the server 14 may be programmed to a server having a memory storing user information; and a plurality of creator computing devices coupled to the server, wherein the server is programmed to: receive and store creative work contributions sent from each creator computing device; automatically process the creative work contributions and organize the creative work contributions as a unified creative work; automatically store the unified creative work with capability of updating the unified creative work; and automatically deliver the unified creative work to the plurality of creator computing devices for engagement by the plurality of creator computing devices.

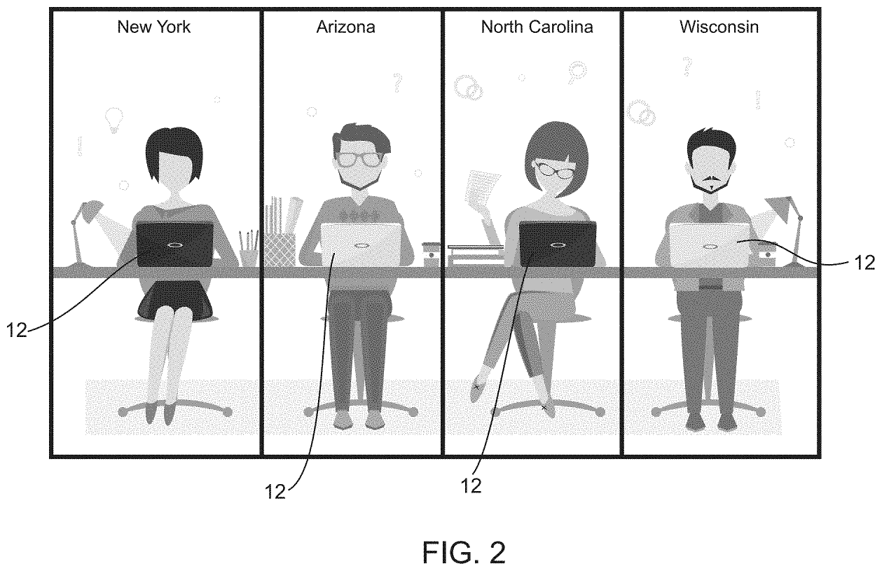

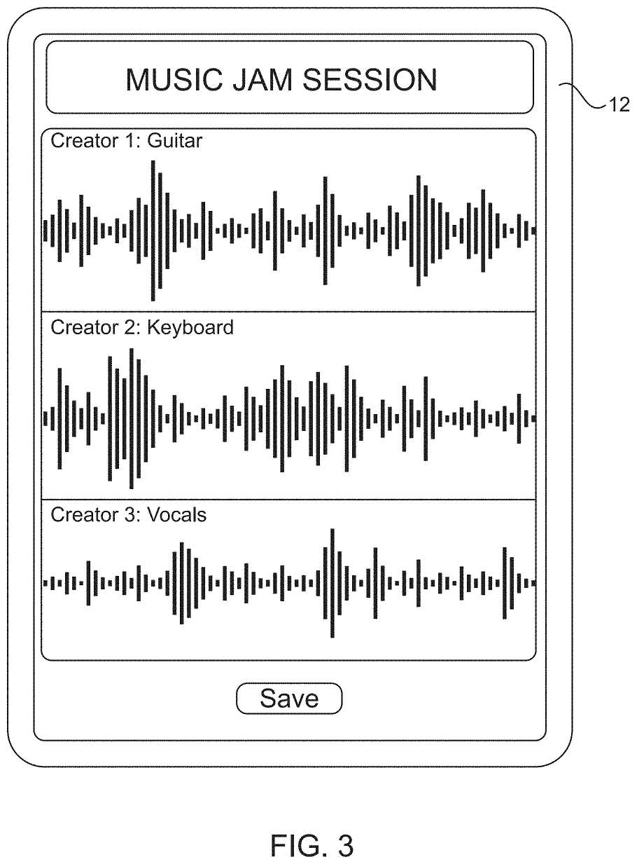

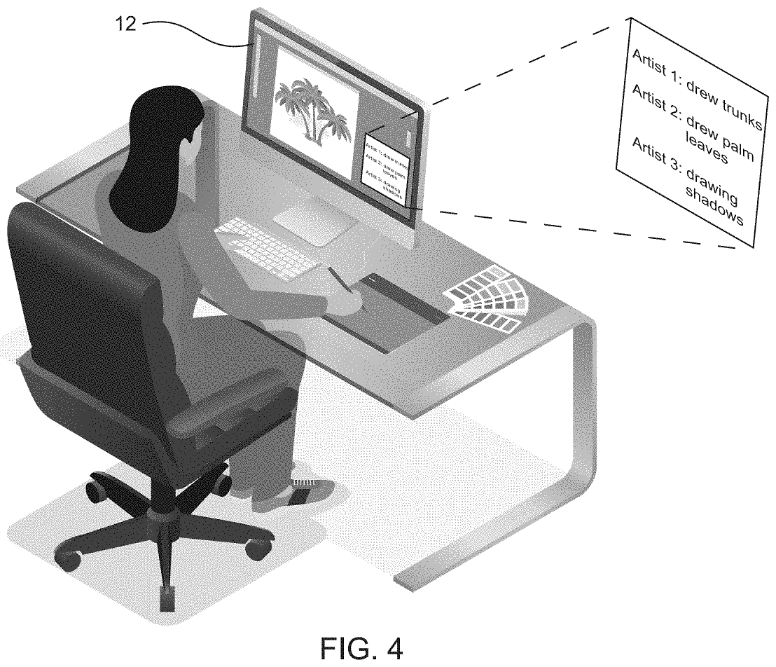

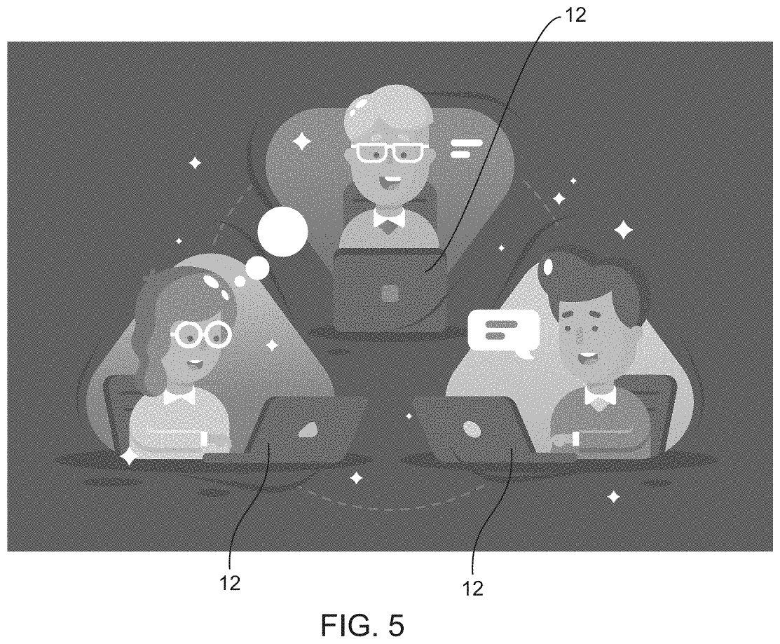

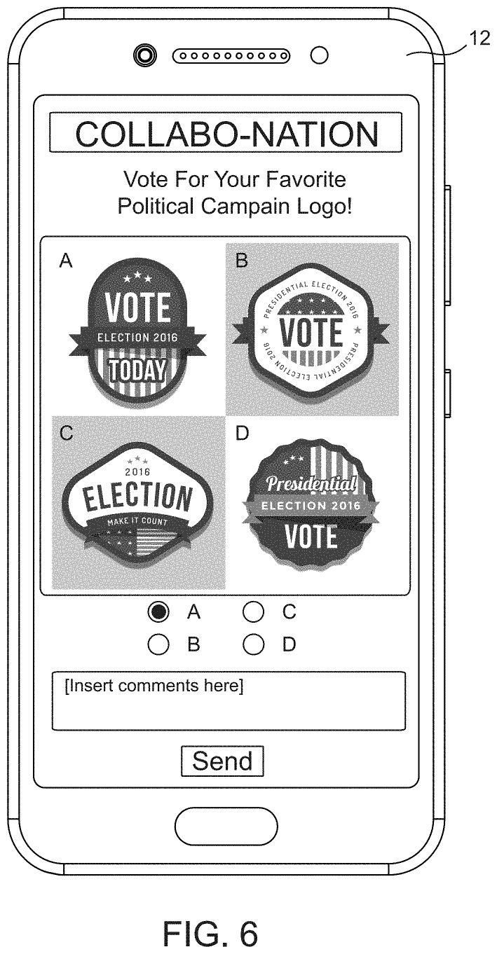

Referring to the drawings again, FIGS. 2-6 depict various uses of the system 10 by creator computing devices 12 that may be available by an embodiment of the creative work collaboration system 10. FIG. 2 shows creator computing devices 12 utilized by several authors that are collaborating on a writing a book utilizing the system 10, wherein each of the authors are located at various locations, such as, but not limited to, New York, Arizona, North Carolina and Wisconsin. FIG. 3 shows a creator computing device 12 operating as part of a creative work collaboration system 10 to engage with music contributions by a plurality of creators as a unified creative work, herein the unified creative work includes each creators musical contribution, such as, but not limited to guitar, keyboard and vocals, for example. FIG. 4 shows a creator computing device 12 operating as part of a creative work collaboration system with an artist engaging with contributions by other creators to modify the unified creative work by adding shadows to the art contributions from the other artists in the group of artists creating the work. FIG. 5 shows a creator computing device 12 operating as part of a creative work collaboration system 10 with a plurality of coders engaging in creating an application, wherein the creators can work simultaneously on the system 10 as part of the collaboration. FIG. 6 shows a creator computing device 12 operating as part of a creative work collaboration system 10 depicting a voting interface for other users of the system 10 to vote on unified creative works, such as a political campaign image as shown in FIG. 6.

The system 10 operates to allow creators to form groups for collaboration on a project, such as a book, a poem, a painting or drawing, a song, an application or the like. The creators may utilize creator computing devices 12. The system 10 operates to connect the creator computing devices 12 that are part of the collaboration group. This server designates areas of memory for the specific creative work or works being generated by the collaboration group. The creators may create a creative work contribution either utilizing the creator computing device 12 or by other means and saved to or accessible by the creator computing device 12. The creator computing device 12 allows the creator to upload his or her creative work contribution, such as a chapter in a book, a music recording, a part of a particular artwork, a portion of code or the like. In embodiments, the creator may designate where the creative work contribution should be located with respect to any other creative work contribution already uploaded and stored in the server 14 corresponding to the collaboration group. In other embodiments, the serve may be programmed to automatically assemble the plurality of creative work contributions into a unified creative work.

The unified creative work may be modified by changing creative work contribution components, adding to the unified creative work or deleting portions of the unified creative work. The system 10 may operate to designate a threshold amount of contribution of each creator in order for the creator to be considered an author or similarly to be listed as a creator of the unified work.

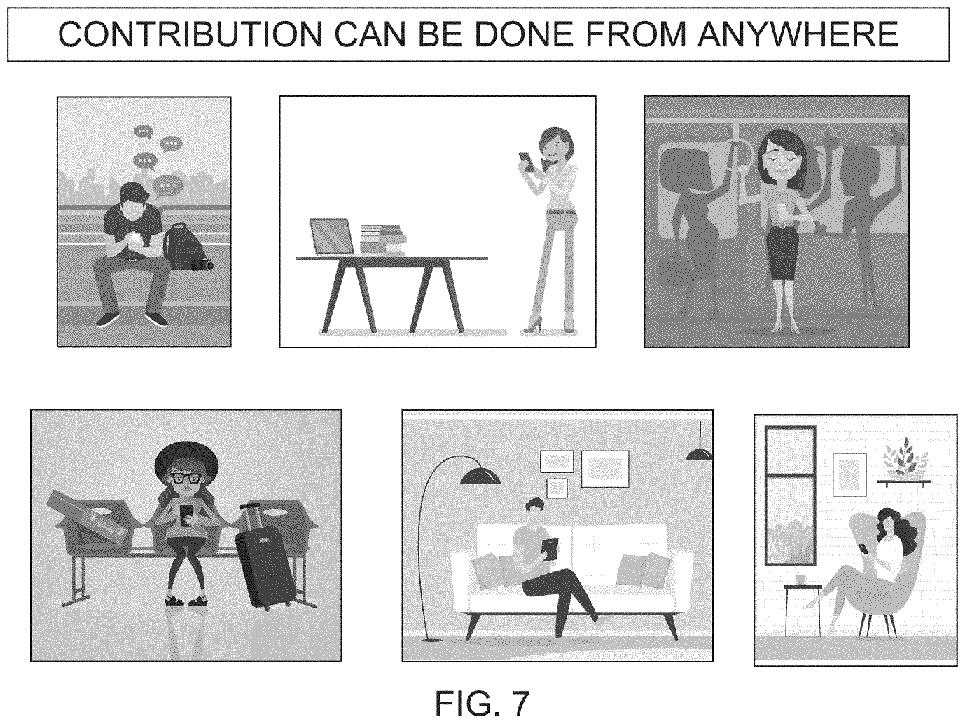

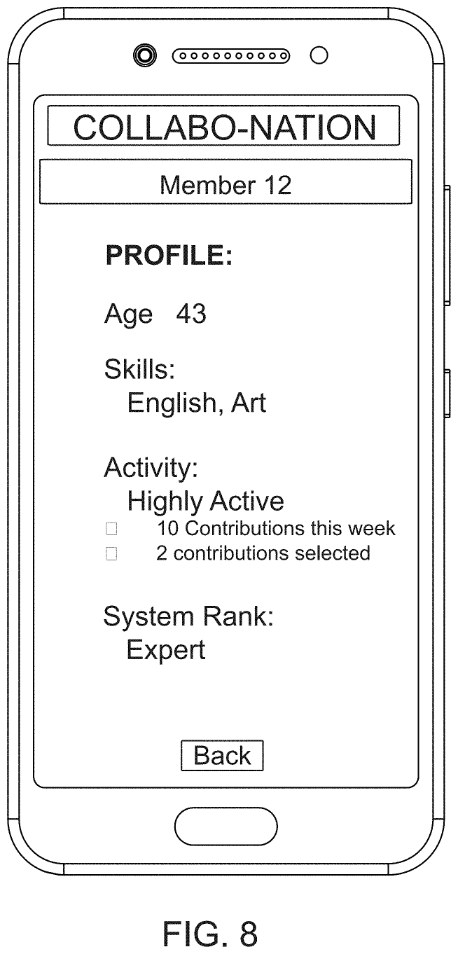

In utilizing the system, creators may engage the system 10 from anywhere at any time, as shown in FIG. 7. This allows creators to occupy their down time with creative work contributions using the system 10 or allows creators to be located in a place that brings inspiration or the like to help in the creative process of developing a unified creative work. The system 10 operates to not only help creators, such as authors, coders, artists, musicians, composers and the like, it becomes an entertainment system for those who seek to contribute. It allows creators to engage for as little or as much time as he or she desires. It can be a 30 second quick vote or it can be hours of contributing. Additionally, creators may include profile information, such as age, skills, activity on the system 10, system rank and the like as depicted in FIG. 8. These profile entries may be utilized by a creator to filter the other creators in order to form a group of creators with whom to collaborate with, and may do so by filtering the available creators.

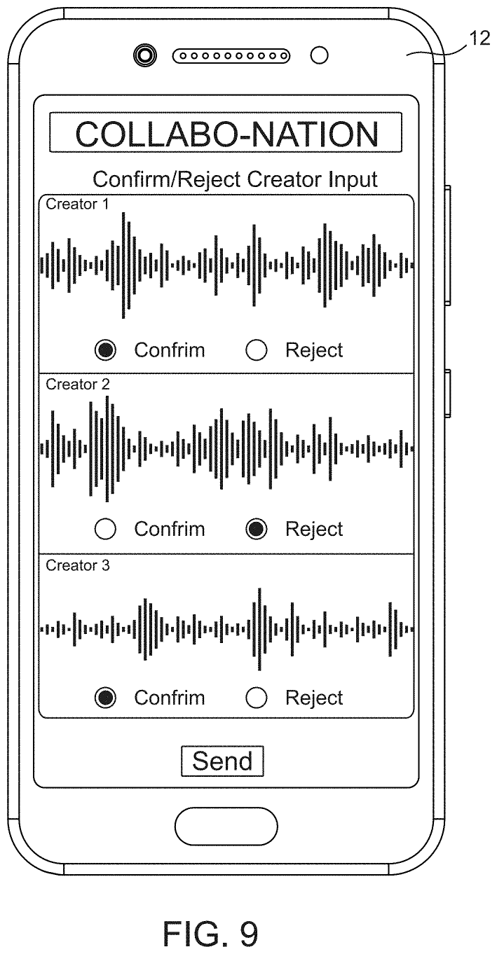

Further, in operation, the creator may access the system 10 utilizing a creator computing device 12. As shown in FIG. 9, the creator computing device 12 may display a unified creative work that the creator contributed to. The interface may include the ability of the creator to confirm or reject each creative work contribution displayed. The system 10 operates to tally the votes by all of the creators and may automatically keep the confirmed creative work contributions and remove the rejected creative work contributions.

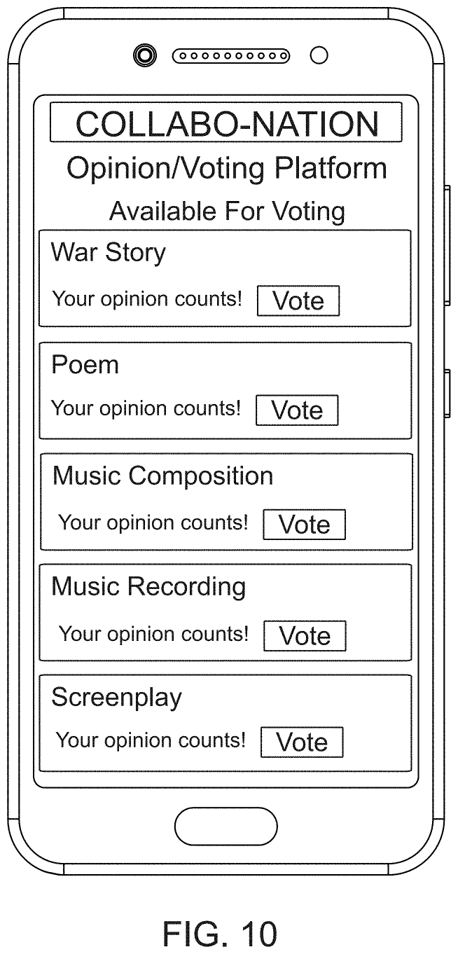

The system 10 may operate with an option for voting or polling, as shown in FIG. 10. Creators may request opinions of other users of the system 10. It allows for these other users to vote on a creative work and provide an opinion, such as like or dislike and to also optionally comment. Because of how the system stores and aggregates data submitted by users, the creator requesting the polling can then sort based on certain demographic or user profile information, for example based on skill, rating level, activity level and the like. Further, embodiments may include weighing votes of certain voters greater than others based on the user profile information and how it corresponds to the creative work being voted on.

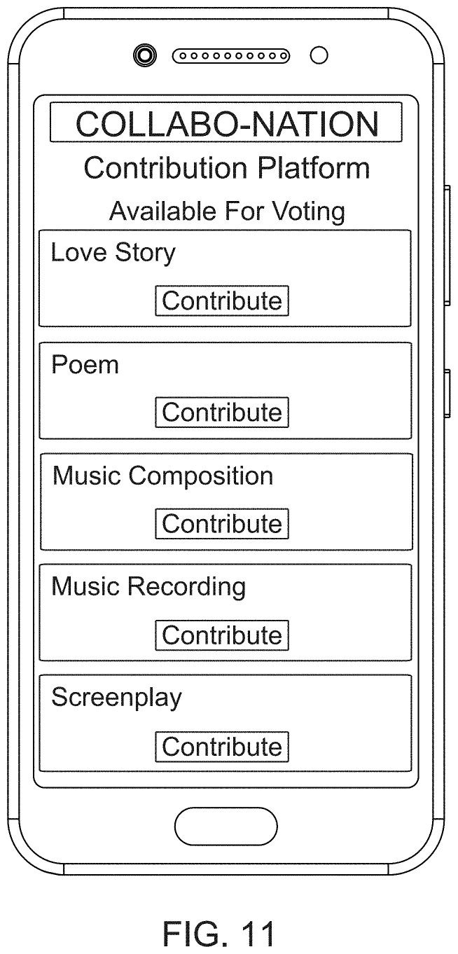

The system 10 may operate with an option for contribution by others, as shown in FIG. 11. Creators may request input of other users of the system 10. It allows for these other users to contribute to a creative work and provide suggestions. The system 10 may then operate to receive contributions from others in a similar manner as disclosed in co-pending application entitled “CREATIVE WORK CONTRIBUTION SYSTEM,” Ser. No. 62/985,295, filed Mar. 4, 2020, the disclosure of which is incorporated entirely herein by reference.

Embodiments may be available on or through the internet, such as through domain names reserved and owned by Applicant that include artist-jam.com, writers-jam.com, coders-jam.com, and opinion-finder.com.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A creative work collaboration system comprising:
a server having a memory storing user information comprising creator profile information, wherein the profile information comprises skill level, rating level and/or activity level of each of the creators;
a plurality of creator computing devices of creators coupled to the server; and
a plurality of other computing devices of users coupled to the server, wherein the server is programmed to:
receive and store creative work contributions sent from each of the plurality of creator computing device;
automatically process the creative work contributions and organize the creative work contributions as a unified creative work, wherein the plurality of creator computing devices comprise an input box for entering and/or voting on the contributions;
automatically store the unified creative work with capability of updating the unified creative work;
automatically deliver the unified creative work to the plurality of creator computing devices for engagement by the plurality of creator computing devices, wherein the profile information is utilized by one of the creators to filter other of the creators in order to form a group of the creators with whom to collaborate with on the unified work, wherein a threshold amount of the creative work contributions of each of the creators must be met in order to be listed as one of the creators of the unified creative work;
receive and store an opinion request from one of the plurality of creator computing devices, wherein the opinion request comprises voting or polling by the plurality of other computing devices;
receive and store the votes or poll responses entered by the plurality of other computing devices in response to the opinion request; and
weigh votes or poll responses of certain users of the plurality of other computing devices greater than others based on the user profile information of the other users and how the user profile corresponds to the creative work being voted on.

2. The creative work collaboration system of claim 1, wherein the plurality of creator computing devices are each a mobile computing device.

3. The creative work collaboration system of claim 2, wherein a mobile application operates on each of the plurality of creator computing device.

4. The creative work collaboration system of claim 3, wherein the mobile application operating on the mobile computing device provides a voting interface for the creators to vote on the unified creative work.

5. The creative work collaboration system of claim 3, wherein the mobile application operating on the mobile computing device provides a display interface for the display of the unified creative work that each of the creators contributed to.

6. The creative work collaboration system of claim 5, wherein the display interface comprises the ability of each of the creators to confirm or reject each of the creative work contributions displayed.

7. The creative work collaboration system of claim 1, wherein each of the creators are located at different locations.

8. The creative work collaboration system of claim 1, wherein the creators form a group for collaboration on the unified creative work.

9. The creative work collaboration system of claim 8, wherein the server designates areas of the memory for the unified creative work generated by the collaboration group.

10. The creative work collaboration system of claim 1, wherein a threshold amount of the creative work contributions of each of the creators must be met in order to be listed as one of the creators of the unified creative work.

11. The creative work collaboration of claim 1, wherein the updating comprises adding or deleting portions of the unified creative work.
